(19) United States
(12) Patent Application Publication
(10) Pub. No.: US 2009/0102424 A1
(43) Pub. Date: Apr. 23, 2009

(54) HIGH RELIABLE SMART PARALLEL ENERGY STORAGE TANK CHARGE/DISCHARGE MANAGEMENT SYSTEM

(76) Inventors: Jenn-Yang Tien, Hsinchu City (TW); Jan-Wu Hong, Hsinchu City (KR)

Correspondence Address: RABIN & Berdo, PC, 1101 14TH STREET, NW, SUITE 500, WASHINGTON, DC, 20005, US

(21) Appl. No.: 11/936,964

(22) Filed: Nov. 8, 2007

(30) Foreign Application Priority Data
Oct. 17, 2007 (TW) 096138804

(51) Int. Cl. H02J 7/00

(52) U.S. Cl. 320/124; 320/126

(57) ABSTRACT

The high reliable smart parallel energy storage tank charge/discharge system is composed of one or multiple identical Smart Energy Storage Unit. And each Smart Energy Storage Unit comprises an Energy Storage Management Module, an Energy Storage Device, a Sensor Switch Device and a Smart Identifier and Transmission Interface. All the historical records and real time information for charge/discharge condition of Smart Energy Storage Unit can upload to external connected equipment via the External Equipment Interface. To operate in coordination with an External Energy (Electric Power) Source, under any one Smart Energy Storage Unit served as the controller, this management system can carry out an effective charge/discharge management. When the Smart Energy Storage Unit which is in charged of the charge/discharge managing failed and cannot operate, the other normally operated Smart Energy Storage Units can automatically detect the situation and replace the role of charge/discharge management immediately so as to accomplish a high reliable charge/discharge management system.

### BACKGROUND OF THE INVENTION

(a) Field of the Invention

The high reliable smart parallel energy storage tank charge/discharge system is an energy storage management system especially specialized in multiple parallel connected Energy Storage Devices. This invention is a system with master/slave configuration. One and the only charge/discharge control center is dynamically selected from fully identical Smart Energy Storage Units. The number of Energy Storage Devices to be charged simultaneously is determined in accordance with the energy of charging source and each Energy Storage Device is being charged in turn so as to lower down the power requirement of electric power source. During the charging process, each Energy Storage Device is allotted the quantity of charging capacity according to the capacity of the Energy Storage Device at that time so as to effectively balance the capacity of Energy Storage Device and prolong the service life time of Energy Storage Device.

(b) Description of the Prior Art

In the natural world, there are different styles of energy can be converted to electrical energy by transforming ways to provide the day-to-day living exercise. The clean energy proposals for transforming the off-peak electricity to chemical energy and stored in the energy storage device or transforming other types of energy to chemical energy and stored for future usage have a common requirement, i.e. a good energy storage mechanism. Because of the difference exists in manufacture technologies and using ranges, the principle tactic of an energy storage configuration is parallel connected multiple sets of energy storage device to lift up the capacity and transient output energy. Owing to the transient surge caused by the changing of loading in very short time and overcharge or over discharge cause by lack of charging and discharging management, the service life of an energy storage device often less than half of the nominal life cycles.

For the electric power source proceeding to charge the parallel connected multiple sets of energy storage unit, the traditional way is to allot all electric power sources to each energy storage device. Because the electric power source is came from transforming of original energy and when the original energy cannot support the energy required by all of the energy storage devices, the charging efficiency will lower down and even damage the service life of energy storage device. The main deficiencies in traditional energy storage system are unable to single charge an energy storage unit alone in a energy storage system configured in parallel connection and unable to separate a energy storage device going to fail. While any one energy storage device failed, in addition to the energy consumption, the heat generated thereof will seriously affect the service life of the energy storage device adjacent to it. The development of the smart parallel energy storage tank management system provides an optimal charging way, a judgment on energy storage device's health condition, separation of failed energy storage device, a balanced capacity for every energy storage device and provides the information of utilized condition for energy storage whereupon is an important way to promote the life cycle of the energy storage system.

### SUMMARY OF THE INVENTION

The main purpose of the present invention is to provide a high reliable Smart parallel energy storage tank charge/discharge management system. By the operation of this system, the charge efficiency can be improved, a consistent capacity for every energy storage device can be achieved, the bad or faulty energy storage device can be isolated, and the service life of energy storage device can be prolonged. This system can flexibly generate the system management. The failure of any single energy storage management module will not affect the system managing and a purpose of high system reliability can be achieved.

The purpose of the present invention can achieve by following methods:

The present invention of High Reliable Smart Parallel Energy Storage Tank Charge/Discharge Management System, as shown in FIG. 1, is composed of over and above one Smart Energy Storage Units (10), External Equipment Interface (20) and External Electric Power Source (30). Each Smart Energy Storage Unit (10) is consists of Energy Storage Management Module (11), Energy Storage Device (12), Sensor Switch Device (13), and Smart Identifier and Transmission Interface (14).

External Equipment Interface (20) is an interface for control software downloading, energy storage device parameters setting, system operation real time monitoring, and energy storage device utilization records reading. The updated management system software can be downloaded through this interface or the system settings be proceeded, the real time information of energy storage device's (12) charge/discharge status be monitored, and historical utilization records of each smart energy storage unit (10) be collected by external connected equipment via this interface also.

Energy storage device (12) is the charge/discharge managing target of the present invention. By input of the applied energy source (expressed by voltage and current) the energy can be stored in the energy storage device. To operate in coordination with different charging ways resulted from different energy storage device characteristics, the input energy must be under control during the charging process to achieve the optimal energy storage efficiency and prolong the service life time.

The sensor switch device (13) is a solid switch which can endure high voltage and high current and can be divided into charge switch and discharge switch. By the input of control signal, the switch can turns on or cuts off the path which the energy flows into or flows out of the energy storage device separately.

The smart identifier and transmission interface (14) provides the connection and signal communication between energy storage management modules. Each energy storage management module is equipped with a connector which provides the connector ID code besides being a transmission signal interface. When different smart identification connector is connected to the same energy storage management module the different and unique ID code is obtained as the identification of data transmitting.

The Energy Storage Management Module (11) is composed of a Micro Control Unit (111), a Synchronization Unit (112), a Data Access Unit (113), and a Display Unit (114). The micro control unit is a microprocessor with built-in flash memory, serial port, multiple sets of analog to digital converter (ADC) inputs, and multiple output ports. Micro control unit acquires time information from synchronization unit (112), reads records from or writes records to data access unit (113), uploads information of energy storage device's utilization status, and displays the state of smart energy storage unit (10). Through the input of analog to digital converter of micro control unit (111), the energy storage management module (11) obtains charge/discharge status and temperature of energy storage device measured by sensor circuit device (131) and then estimates the State of Charge (SOC) or so called Depth of Discharge (DOD) for energy storage device. Charge/discharge control center is a software function existing in the energy storage management module (11). Only one software function of the charge/discharge control center of an energy storage management module in whole system is in operation mode at any time. The charge/discharge control center schemes out the charge/discharge management procedures based on each energy storage management module's (11) energy storing status of energy storage device, charging time or depth of discharge reported via smart identifier and transmission interface and commands instructions to control actions of forward charge switch (132) and backward discharge switch (133) for the process of charge and discharge.

The software configuration of the present invention of High Reliable Smart Parallel Energy Storage Tank Charge/Discharge Management System, as shown in FIG. 3, can be divided into 5 units based on respective function including gas gauge management unit (1100), sensor and control unit (1110), data storage management unit (1120), communication unit (1130) and charge/discharge management unit (1140). Every energy storage management module has the same built-in software, however only one energy storage management module (11) of a smart energy storage unit starts up its charge/discharge management unit module, i.e. to serve as a charge/discharge control center (1100). Other energy storage management modules not serve as charge/discharge control center only start up their another four software function modules to proceed sensor controlling, data storing and acquiring, and transmit data to charge/discharge control center according to commands. Charge/discharge management unit (1100) is the charge/discharge control center which acquires state information of smart energy storage unit (10) through communication unit (1130) and communication interface (14) as the bases to scheme out the charging procedure and to start up the charging procedure or to stop a specific smart energy storage unit (10) from continuing discharge at appropriate occasion such as an external electric power source is removed or the capacity of the energy storage device is lowered down to a certain level. Communication unit is the driving program of the serial transmission interface that can proceed a point-to-point addressed transmission and also can sent commands to all smart energy storage units (10) at the same time by the way of broadcasting. For the role of transmission, the charge/discharge control center is also called a master controller. Each data exchange is commanded by instructions sent from the charge/discharge control center. The other energy storage management modules with non-charge/discharge control center are slave devices which communication units can only passively receive and reply the instructions of master controller. Addressed transmission is received and replied by specific smart energy storage unit (10) while command broadcasting is received by all smart energy storage units (10) but need not to reply. Sensor and control unit (1110) reads the value of input voltage which is deduced from physical characteristic parameters (voltage, current, temperature) from sensor unit (131) of sensor switch device (13). Gas gauge management unit (1100) is the core unit of smart energy storage unit which is in charge of estimating the energy storing status and health condition of the energy storage device and reports the charge/discharge status of energy storage device to charge/discharge control center via communication unit (1130), meanwhile, accepts instructions came from charge/discharge control center to control the switching of forward charge switch (132) and backward discharge switch (133) to implement the whole system's charge and discharge management. Data storage management unit (1120) is in charge of writing to and reading from the storage unit (113) which can periodically store the charge/discharge parameters or unexpected conditions (exceptions) of energy storage device and can upload the charge/discharge records of each energy storage device for further analysis via the external equipment interface (15).

When the charge/discharge control center cannot normally carry out charge/discharge controlling for some reasons, a new charge/discharge control center can be generated by performing the control transfer algorithm in each energy storage management module (11) and then the charge/discharge control mission can be carry on. The whole system will not stop operating because of failure of specific smart energy storage unit (10) and achieves the feature of high reliability.

By scheming out the wiring for connector identification code of smart identifier and transmission interface (14), in the high reliable smart energy storage tank charge/discharge management system of present invention each smart energy storage unit (10) is given a unique ID code. Through the master controller assignment algorithm, a charge/discharge control center can be selected from all smart energy storage units and the charge/discharge management unit (1140) starts. The charge/discharge control center dominates the charging rotation sequence for every smart energy storage unit (10) and determines the charging condition for each energy storage device and judges the health condition for energy storage unit by periodically inquiring the values of voltage, temperature and charging current of each energy storage device in turn. A bad energy storage device will be isolated from the system when necessary.

Under the master-slave configuration, only one energy storage management module (11) can be the master controller. The other energy storage management modules (11) are slave devices. The master controller is the charge/discharge control center which is in charge of scheming out the charging procedure, charging time management, and energy storage device status inquiring. When an external electric power source is detected by the charge/discharge control center, the energy storage devices are to be charged in turns according to the planned charging target. According to the charging condition at the time, the charge/discharge control center adjusts the number of energy storage device to join the charging process. Each energy storage device can be charged effectively and be charged in accordance with the charging characteristic conform to the energy storage device. For the energy storage device with low depth of discharge (higher remaining capacity) must be postponed to join the charging queue in turns until the energy storage device with higher depth of discharge being charged to the same level of capacity. Under the control of the charge/discharge control center, every energy storage device can complete the charging process at the same time.

The command and data exchange between charge/discharge control center and each energy storage management module (11) is implemented via smart identifier and transmission interface (14). The hardware and internal control software of energy storage management modules (11) are totally the same and can be substituted arbitrarily. By the wiring of connector identification code, each energy storage management module is given a unique ID code. Through the ID code, the control software can receive and process the commands sent from charge/discharge control center.

The energy storage management module (11) gets its device address by reading out the wiring ID code. The charge/discharge control center realizes a pulse charging by sending charge or stop charge commands to each energy storage management module (11) in turns. The charge/discharge control center schemes out an optimum charging way according to the output power of external electric power source and the charging characteristic of energy storage device. FIG. 8 depicts a typical charge/discharge control sequence. Before time T, charge/discharge control center schemes out two energy storage devices being charged at the same time and then three energy storage devices being charged at the same time after time T. The charging period P is an adjustable parameter.

### BRIEF DESCRIPTION OF THE DRAWINGS

FIG. 1 is a configuration diagram of the smart parallel energy storage tank management system of the present invention.

FIG. 2 is a block diagram of the energy storage management module of the present invention.

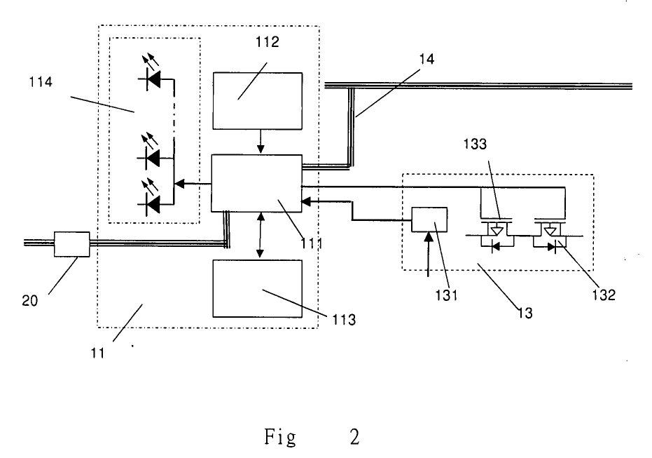

FIG. 3 is a software functional block diagram of the energy storage management module of the present invention.

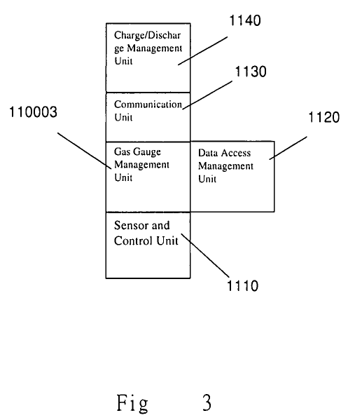

FIG. 4 is a functional block diagram of the master/slave configuration of the present invention.

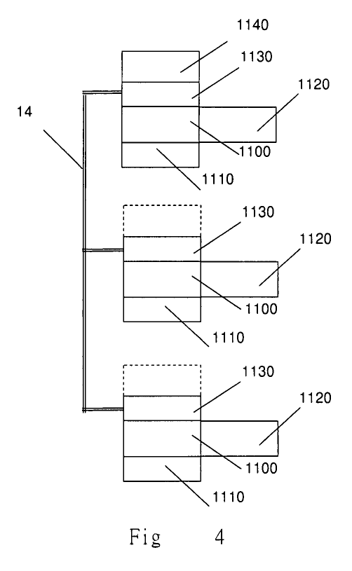

FIG. 5 is a flow chart of the master controller designation procedure of the present invention.

FIG. 6 is a sequence diagram of the master controller designation procedure of the present invention.

FIG. 7 is the in turn charge/discharge flow chart of the smart energy storage unit of the present invention.

FIG. 8 is the charging sequence diagram for adding the smart energy storage unit of the present invention.

FIG. 9 is the charging sequence diagram for part of the smart energy storage units do not charge of the present invention.

### DETAILED DESCRIPTION OF THE PREFERRED EMBODIMENTS

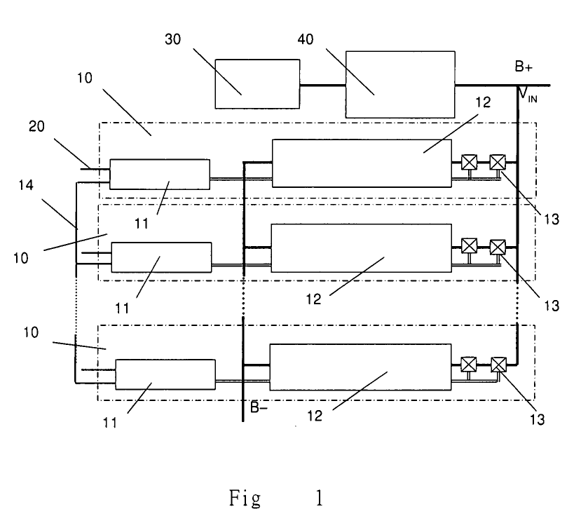

The Smart Parallel Energy Storage Tank Charge/Discharge Management System of present invention is an electric power system composed of multiple parallel connected smart energy storage units (10). The whole system configuration, as shown in FIG. 1, is composed of one set above smart energy storage unit (10), external equipment interface (20) and external electric power source (30). The smart energy storage unit (10) includes energy storage management module (11), energy storage device (12), sensor switch device (13) and smart identifier and transmission interface (14).

After the system being started up, by performing the master controller designation procedure, a one and only charge/discharge control center is generated among all energy storage management modules. The charge/discharge control center continually acquires the energy storing and charge/discharge statuses of energy storage devices for all energy storage management modules in the system to scheme out the most appropriate charge/discharge procedure.

The energy storage management module (11) detects voltage, current and temperature of energy storage device via sensor switch device (13) to judge the energy storage and health statuses and accepts commands sent from charge/discharge control center to turn off charge or discharge switches. The energy storage device (12) is a substance which has the energy transforming and storing characteristics that transforming the external electric energy into chemical energy and storing the energy or transforming the internal stored chemical energy into output electric energy.

The charge/discharge control center of present invention continually obtains related information of energy storage device for each energy storage management module by the way of periodical inquiring. The information includes status message, charging capacity, voltage of energy storage device, charge or discharge current, maximum energy storage capacity of energy storage device, etc. The charge and discharge management is schemed out based on the above information. When the energy storage management module which the charge/discharge control center is located or the energy storage device is failed and do not inquire the status of energy storage device for each energy storage management module in the time period planned, each energy storage management module can detects and determines the master controller in charge of the charge/discharge control center is failed and then a new master controller is automatically generated to take on the charge/discharge control center by the Master Controller Designation Algorithm of the present invention.

The Master Controller Designation Algorithm is as followings:

### (0) Normal Operation:

Master controller inquires the information of energy storage device in turn for each energy storage management module per time t₁and, after the time t₂=t₁×n (n is the number of smart energy storage unit in whole system), can repeat inquiring the same energy storage management module once again.

### (1) Starting Up the Master Controller Designation Procedure:

When the preset time interval t₃ (t₃>>t₂) is past and the energy storage management module did not receive the status inquiring command sent from master controller (master controller timeout), this energy storage management module starts up its master controller designation procedure. Or, after system powered on and completed initialization task, the energy storage management module will immediately start up the master controller designation procedure also.

### (2) Active Time Slot and Target Energy Storage Management Module Address:

According to the addresses of energy storage management modules, one energy storage management module's address is set as a target address every other time interval t₄ (called active time slot). If the target address matches the address of itself, the energy storage management module obtains the control right and becomes a new master controller.

### (3) New Master Controller Broadcasting:

The energy storage management module which has obtained the control right sends a command by broadcasting to inform all energy storage management modules the control right has been obtained, and then start to inquire the status parameters of each energy storage management module in turn. The new generated charge/discharge control center immediately starts up the charge/discharge management function.

### (4) Other Energy Storage Management Modules:

After received the broadcasting command (an energy storage management module has already obtained the control right), other energy storage management modules which are still performing designation procedure will terminate the master controller designation procedure and return to simple energy storage management module function.

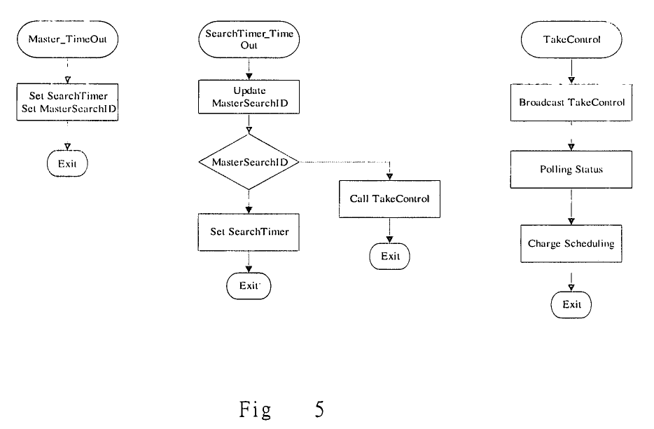

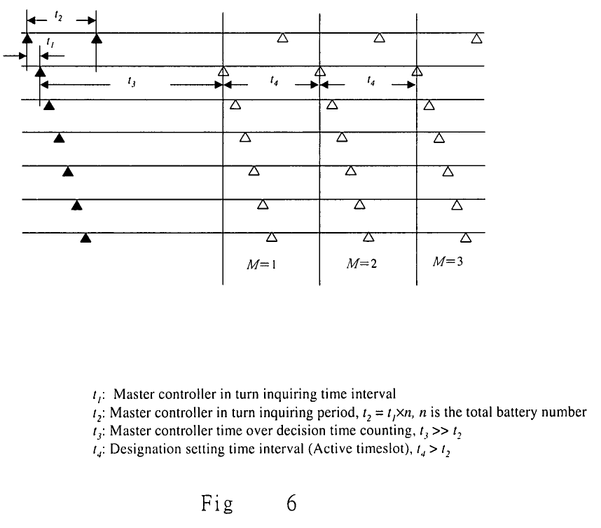

FIG. 5 depicts the block diagram for master controller designation algorithm and FIG. 6 is the corresponding timing sequence diagram. Under normal operation, charge/discharge control center sends out a status inquiring command for every one rotational inquiring time interval. Every energy storage management module receives the inquiring from charge/discharge control center for every t₂ time interval. If the energy storage management module did not receive any command sent from the master controller after time t₃ (called the master controller timeout decision timing) got past, the master controller or communication interface would be determined to have something wrong with it and would not execute the task of charge/discharge control center. At this moment, the master controller designation procedure is started up and set the active time slot as the first time slot (m=1). If the energy storage management module which address matches the active time slot (Address=m=1) were operating normally, a broadcasting command will be send in the first time block to acquire the control right. If this energy storage management module were not operating normally, no action will be taken in the first active time slot. After t₄ time period elapsed, the second energy storage management module, with address matches active time slot (m=2), can then send out the broadcasting command to acquire the control right. Through this algorithm, the master controller designation can be accomplished at the time of t₃+t₄×n at the latest. Besides the original charge/discharge control center failure, this procedure is also applied for the first charge/discharge control center generated during the initialization process.

Every energy storage management module can acquire an individual active time slot according to its transmission interface address and can send out the declaration of control right acquiring at this active time slot. By means of setting smart identifier and transmission interface, the addresses of energy storage management modules are assigned with continuous n numbers. The n active time slots correspond to the n energy storage management modules.

Besides the original charge/discharge control center failure, this procedure is also applied to assign the charge/discharge control center at initialization phase. Except for the new master controller re-designated by starting up the master controller designation procedure at the just moment that the initialization procedure is completed or master controller did not demand the status for each energy storage management module in preset time period. When external equipment connects with any one energy storage management module through the external equipment interface, the control transfer will take place too.

External equipment interface is the interface between external and the system of the present invention. Every energy storage management module has an external equipment interface. Through the external equipment interface, any related charge/discharge information of the energy storage management module can be read out. If all the information of energy storage management modules were to be acquired by a single external connected interface, the information of each energy storage management module must be read out by the energy storage management module serving as master controller and then sent out through the external equipment interface of master controller. Any one energy storage management module of the present invention can acquire the control right through the transmission interface control transfer procedure and then ask each energy storage management module to reply to the inquiry of external equipment. The management procedure for control transfer starting up by external equipment is as followings:

(1) External Equipment Connecting Request

External equipment requests the energy storage management module (m₁) for connection via external equipment interface (20). If the energy storage management module which received the connection requisition were the current master controller, it can reply to the external equipment that the connection is established, otherwise:

(2) Control Transfer Request

The energy storage management module issues the “control transfer request” in the status reported.

(3) Master Controller Response:

While inquires to each energy storage management module the original master controller (m₂) detects the control transfer request issued by a specific energy storage management module, thereupon answers the energy storage management module a “control transfer grant” command and changes the transmission interface from active transmission function to passive receiving function.

(4) Control Right Take-Over.

After received the “control transfer grant” command, the energy storage management module (m₁) changes the transmission interface to active transmission function and then, by broadcasting, notifies all energy storage management modules that the control has been transferred.

(5) Reply to External Equipment

The energy storage management module (m₁) responses the external equipment interface that the connection has been established.

(6) Charge/Discharge Management Center

Meanwhile, the energy storage management module (m₁), which has taken the control of the communication authority among modules, serves as the charge/discharge management center and starts up the charge/discharge management function.

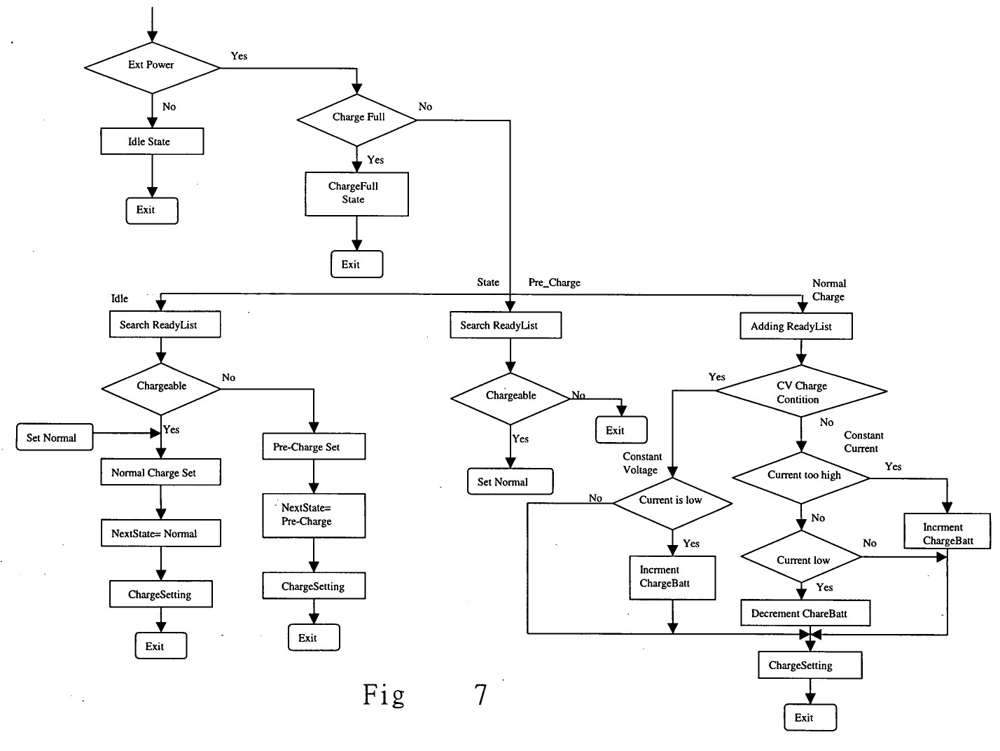

The charge/discharge management center schemes out the charge procedure based on the energy storage device's status reported from each energy storage management module and enters the charge management procedure at the moment that an external electric power source is detected. The charge management procedure is as shown in FIG. 7. The charge management procedure (FIG. 7) is sure to execute once per charge management cycle. The execution flow path is determined by the status at the moment of executing. Charging states is denoted as four states: Idle, Full-Charge, Pre-Charge and Normal-Charge, etc.

When external electric power source disappeared, the charging procedure is at idle state. While at idling, the charge/discharge control center does not manage charging and the charge and discharge switches are turned on so that the energy storage device is in a state of allowing charge and discharge. The system is in the state of Full-Charge if all energy storage devices had been fully charged. Because the external electric power source is still existed at Full-Charge state, all the charge switches must be turned off to prevent the energy storage device from being over charged. The charge/discharge control center determines the operation procedure according to the states at that time for the other situations.

When the input of external electric power source has been detected, if the state were at Idle state, the “Search Ready Energy Storage Device” procedure will find out the energy storage device with lowest capacity and all the energy storage devices which have the capacity difference, differ from the lowest one, under the limit range to be the “Chargeable Energy Storage Device” according to the state information acquired from each energy storage management module. If the number of “Chargeable Energy Storage Device” exceeded the preset “minimum charge number”, the system is at “Chargeable State” and change the charging state to Normal-Charge. “Charge Setting” selects the “minimum charge number” of energy storage devices in turn from “chargeable energy storage device” and sends charge command to the selected energy storage management module to proceed to charge simultaneously. If the number of “Chargeable Energy Storage Device” were less than the “minimum charge number”, the charging state is at “Pre-Charge State”. A “minimum charge number” of energy storage devices start from the energy storage device with lowest capacity, will be selected and proceed to charge. Based on the selected energy storage device, the master controller sends charge command to associated energy storage management module and proceeds to charge simultaneously. While pre-charging, the capacity difference between “minimum charge number” energy storage devices in charging exceed the limit range so that there is larger difference of charging current for each energy storage device. The lower capacity the energy storage device has lower internal impedance and more charge current it gets.

If the state were Pre-Charge at beginning of charge, the strategic decision of the charge management is similar to that of Idle-State. If the number of “Chargeable Energy Storage Device” exceeded the preset “minimum charge number”, the condition is “Chargeable” and the charging state is changed to Normal-Charge. “Charge Setting” procedure selects “minimum charge number” of energy storage devices in turn from “chargeable energy storage device” and sends charge command to their energy storage management module to proceed to charge simultaneously. If the number of “Chargeable Energy Storage Device” did not reach the preset “minimum charge number”, the energy storage device under charging is kept charging until the capacity of the lowest energy storage device is raised to has a capacity difference, differ from other energy storage devices, less than the limit. The “minimum charge number” is related to the output power of external electric power source and permissible charging current of energy storage device and stored in flash memory as one of the charging parameters. According to the actual application environment, different charging modes can be schemed out by modifying the charging parameters in the flash memory.

If the charging state were “Pre-Charge” at beginning of charge, because the capacity of energy storage device is increased during the process of charging, the number of energy storage device with capacity difference less than the limit is also increased. Each time the charge takes turns, the “Search New-added Ready Energy Storage Device” procedure checks the energy storage device with originally higher capacity to decide to join into the charging queue. Then, according to the situations of charging voltage and current, the number of energy storage device for simultaneously charge is determined. The energy storage device with lower capacity will have a relatively large charging current and is charged as constant current. The number of energy storage device for simultaneously charge is adjusted in accordance with the charging current (i.e. output power of external electric power source) to make each energy storage device obtaining an enough but not overtaking charging condition and to ensure that the energy storage device is being charged under the optimal conditions. When the capacity of energy storage device reached a certain level, the charging voltage will be kept at a certain level and the current will lower down gradually, which is denoted as constant voltage charge. During the constant voltage charge, the number of energy storage device for simultaneously charge can be increased gradually to fully utilize the output power of external electric power source. In such a way, all the energy storage devices can complete the charge within a relatively short time period.

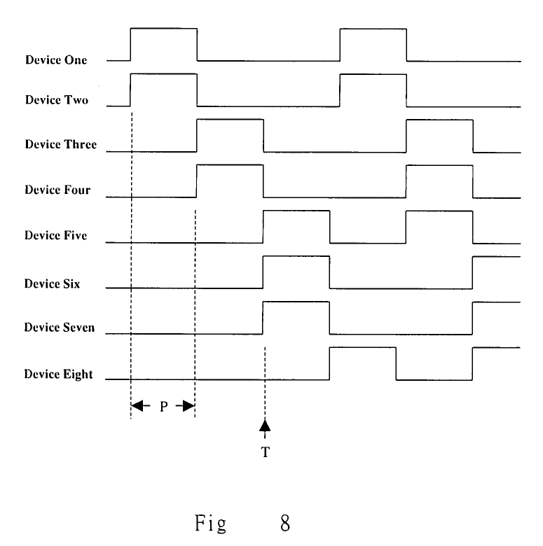

FIG. 8 is a diagram of charging sequence where p is the charging period. Before time t, there are two energy storage devices being charged simultaneously in each charging period. At the time t, the management procedure decides to increase the number of energy storage device for simultaneously charging, and therefore the energy storage devices of five, six and seven are being charged simultaneously and the energy storage devices changed to eight, one and two to be charged simultaneously in the next period.

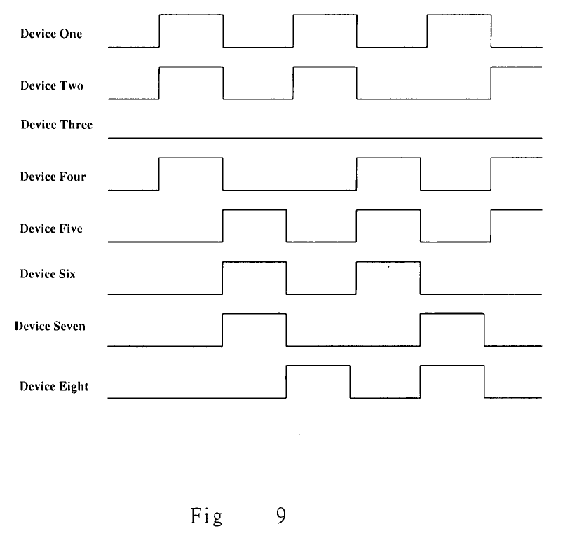

When charge/discharge control center reads out the status of each energy storage device, the abnormal or full charged energy storage devices will be excluded from the charging queue to effectively utilize the charged energy and also expedite the charging speed. FIG. 9 is a sequence diagram showing that there are three energy storage devices participate in the charging each time while an energy storage device (energy storage device 3) does not participate in the charging.

When an energy storage device is charged to a certain capacity by way of constant voltage charging and the charging current is lowered down under the preset limit, the charging process of the energy storage device is determined to be fulfilled. The charge status of energy storage device reached 100% or the depth of discharge is recovered to 0. The energy storage management module of the present invention can estimate the maximum charging capacity of the energy storage device at that time in accordance with the charging ratio (SOC) before charging, original maximum charging capacity (FCCAP) and total charging quantity (CCAP) in charging process. The calculating formula is: new(FCCAP)=original(FCCAP)×SOC+CCAP. The maximum charging capacity will gradually decrease as the energy storage device aging and is the major principle to estimate whether an energy storage device is reached its usage life limitation or not.

Because of the intrinsic quality difference of manufacture or raw material and different environment of the installed location, the energy storage devices which are parallel connected with each other will have certain level of capacity differences after being charged and discharged many times, even some energy storage devices among them had degraded to a degree of should not keep putting to use. The energy storage management module of the present invention can accumulate the actual discharged capacity of energy storage device during the discharge process and the master controller can detect the over low discharged energy storage module by compare the actual discharging quantity difference of each energy storage device. When the discharging quantity is lower under the preset limit, it is to be displayed by the display unit (114) and recorded in the data record access unit (113) as the reference information for maintenance.

Besides serves as the master controller to actively determine the charge and not charge of each energy storage management module or passively receives the commands sent from master controller to process the in turn charge, the energy storage management module of the present invention can possible be in the third identity called standalone mode. The reasons of moving into standalone mode can be the following: the transmission interface of energy storage management module is unable to operate normally caused by some reasons or the whole system is indeed composed of one energy storage device arranged in pairs with a energy storage management module. The comparison is completed in the active time slot of the master controller designation procedure (FIG. 5 and FIG. 6). After get the control right, the energy storage management module will notify all energy storage management modules that the control right has been acquired. If the transmission interface were not operating normally or there were no other energy storage management module existed in the system, the broadcasted command will not get response from any energy storage management module and then that energy storage management module will change its operating mode from master controller mode to standalone mode. If already served as a master controller and were processing the status inquiring for each energy storage management module and all energy storage management module gave no answers because of the transmission interface failure, then the original master control module operation mode will change to standalone mode too.

There are no master controller controls both the charge and discharge process under standalone mode. Each energy storage management module in this system will hold the charge switch and discharge switch in turn on position and keep itself in chargeable and dischargeable status on the go. When the energy storage management module has detected the charging voltage reaching the maximum charging voltage, it will turn off the charging switch to stop charging process by itself. The condition is the same in the discharge process. If the voltage of energy storage device or the capacity of energy storage device were under the preset lower limit value, the energy storage management module in standalone mode will turn off the discharging switch to stop discharging process by itself also.

To sum up, the High Reliable Smart Parallel Energy Storage Tank Charge/Discharge Management System of the present invention is capable of attaining the following purposes and results while meeting patentability elements of novelty and progressiveness of a patent:
1. The present invention discloses a Smart Parallel Energy Storage Tank Charge/Discharge Management System comprised of multiple smart energy storage unit. Each smart energy storage unit is composed of energy storage management module, data transmission interface, charge/discharge control switches, sensor switch device, and energy storage device. Through the master controller designation procedure, one of the energy storage management modules also serves as the charge/discharge control center. The whole system is configured to be a dynamic adjustable master/slave smart energy storage tank management system. (Configuration)
2. The present invention discloses a master/slave smart energy storage tank management system. Every smart energy storage unit connects with the active smart energy storage unit to form a charge/discharge management system comprising parallel connected multiple energy storage devices. Each single smart energy storage unit can stand alone operate as a charge/discharge management module with single energy storage device. (Flexible configuration)
3. The present invention discloses an in turn charging management method which achieves lowering down the charging power demanding and use the charging current and voltage of each energy storage device to accurately control the actual charging efficiency of each parallel connected energy storage device and detect the energy storage device with bad energy storage. (Reduce power demanding of external electric power source and detect unhealthy energy storage device)
4. The present invention discloses a dynamic master controller designation procedure which has fault tolerance ability for distributed operation of multiple energy storage management system and achieves a high reliable energy storage system. (reliable fault tolerance ability)
5. The present invention discloses a charge/discharge control center which schemes out the circulating in turn charging method for the energy storage units needed to be charged in accordance with the conditions reported from each energy storage unit. This method can achieve the purpose of raising the charging efficiency during the charging progress and effectively making use of all the energy in charging. This method can solve the problem of energy consumed by giving out heat and damage the life of energy storage device caused by traditional method which handles the full charged energy storage device through a bypass load. (fully utilize the charged energy, high charging efficiency, reduce energy consumption)
6. The present invention discloses a method that the master controller sends out commands to turn off charging and discharging switches to isolate the bad functional or fault energy storage device to avoid the charging energy being consumed by the fault energy storage device and to keep off overheating generated from reverse charging which damages the life of energy storage device. (screen out bad energy storage device, reduce energy consumption, prolong the life of energy storage device)
7. The present invention discloses an energy storage management method, by the management of discharge switch, that keeps the system operating normally under the condition of a limited number of energy storage devices being fault or performance decayed. (normally put to use even bad energy storage device presents)
8. The present invention discloses a fault tolerant high reliable charge/discharge management system which can operate normally under the condition that the communication failed for multiple energy storage devices being charged in turn and for a stand alone energy storage device being continuing charged. (high reliability and fault tolerance ability)

I claim:

1. A high reliable smart energy storage tank charge/discharge system. The system comprises multiple identical smart energy storage units, an external equipment interface and an external electric power source. Wherein the smart energy storage unit comprises an energy storage management module, an energy storage device, a sensor and switch device, a smart identifier and transmission interface.

2. The high reliable smart energy storage tank charge/discharge management system as claimed in claim 1, wherein the external equipment interface provides an interface for real time reporting the condition of energy storage device, energy storage device utilizing record data collecting and the management system maintaining.

3. The high reliable smart energy storage tank charge/discharge management system as claimed in claim 1, wherein the energy storage management module is the dominant unit of charge/discharge managing which includes a micro control unit, a synchronization unit, a data access unit, a display unit and a communication interface.

4. The smart energy storage unit as claimed in claim 1, wherein the energy storage device is especially an energy storage mechanism that requires large current to proceed to charging and to reach the optimum energy storage effect.

5. The smart energy storage unit as claimed in claim 1, wherein the sensor and switch device is composed of a voltage/current/temperature transforming circuit, a forward (charge) switch circuit and a backward (discharge) switch circuit.

6. The voltage/temperature/current transforming circuit as claimed in claim 5, wherein the voltage and temperature transforming circuits respectively transform the terminal voltage of positive/negative electrode of energy storage device and the temperature of energy storage device into corresponding voltages with appropriate range. The current is a measurement of the current flowing through the conducting wire in accordance with the Ampere's right-hand rule without interfering to the charging and discharging current and expressed in corresponding voltage with appropriate range.

7. The smart energy storage unit as claimed in claim 1, wherein the smart identifier and transmission interface is the medium which each energy storage management module defines the transmission messages and control commands. Through the smart identifier circuit, a unique identification can be assigned to each completely identical smart energy storage unit and can be the basis of the smart energy storage unit to receive the command or to answer the command while communication transmitting.

8. The energy storage management module as claimed in claim 3, wherein the micro control unit uses the analog to digital (A/D) converter input to read in the voltage values representing respectively the voltage, temperature and current mentioned in claim 6 and, after calculation, deduce the terminal voltage, current flowing in or flowing out of energy storage device and the temperature of the energy storage device whereupon continuing estimate the actual charging capacity or depth of discharge of the energy storage device.

9. The energy storage management module as claimed in claim 3, wherein the micro control unit uses the charge/discharge states, temperature and terminal voltage of the energy storage device obtained in claim 9 to determine whether the energy storage device is suitable for continuing charging or discharging or must stop the charging/discharging. The charge/discharge controlling is achieved by controlling the charge/discharge switches mentioned in claim 7 by the digital output.

10. The energy storage management module as claimed in claim 3, wherein the synchronization unit is a standard timekeeper and its application circuit. While system is connecting, a synchronous clock can be obtained to be the timing reference of controller data login. By means of the electric energy storage of the energy storage device, the clock can keep time counting with extremely low energy consumption and will not loss its function because of over low system power.

11. The energy storage management module as claimed in claim 3, wherein the data access unit is a flash memory and its application circuit and serves as the storage medium for charge/discharge and abnormal messages during the operation period of an energy storage device.

12. The energy storage management module as claimed in claim 3, wherein the display unit is the indication medium for the operation conditions of the charge/discharge management system.

13. The multiple identical smart energy storage units as claimed in claim 1, wherein the individual energy storage management unit, by the way of the synchronous power supply and the unique identification given in claim 8 and through the master controller designation procedure, a unique one and only energy storage management unit is determined to be the charge/discharge control center among all energy storage management units to carry out the charge/discharge management for the whole system.

14. The multiple identical smart energy storage units as claimed in claim 1, wherein the master controller designation procedure, when the master controller previously determined cannot normally carry out the charge/discharge management, the other normal operating energy storage management units can automatically detect the abnormity and then start up the master controller designation procedure to generate a new master controller to take over and carry on the charge/discharge management.

15. The multiple identical smart energy storage units as claimed in claim 1, when external equipment sends out a command via the external equipment interface of any one smart energy storage unit, the smart energy storage unit which connected to that external equipment can acquire the communication master control right via the control transfer request procedure and take over to carry on the charge/discharge management.

16. The charge/discharge control center as claimed in claim 14 schemes out the optimal charging plan according to the charging characteristics of energy storage device and the output power of external power source whereupon makes the energy storage device which turned on its charging switch obtaining the most appropriate charging energy so as to hold the charging efficiency and energy storage ability of energy storage device and effectively utilize the output power of external power source.

17. The charging plan as claimed in claim 16 is using part of the smart energy storage units to proceed to charging and makes the other smart energy storage units to turn off their charging switches to enter a phase of relaxation. By the timing management, all energy storage devices obtained charging in turn so as to achieve the pulsed charging effect.

18. The pulsed charging control as claimed in claim 17, whereupon, according to the terminal voltage and the charging current of smart energy storage unit in charging, the charge/discharge control center dynamically adjusts the number of smart energy storage unit for being charged at the same time during the in turn charging switching progress so as to achieve the purpose of effectively utilizing the output power of external power source.

19. The pulsed charging control as claimed in claim 18, whereupon, for the smart energy storage unit which completed its charge or been decided to be failed, the charge/discharge control center will not bring it into the charge list in the next cycle for the plan of charging the smart energy storage units so as to shorten the charging period and improve the charging efficiency.

20. The pulsed charging control as claimed in claim 18, whereupon, when the capacity of an energy storage device rose up to a certain level, the charging current will lowering down gradually, and therefore the charge/discharge control center will increase the number of smart energy storage unit which being charged simultaneously and then all energy storage devices are charged and completed the charging process simultaneously.

21. The smart energy storage tank charge/discharge management system as claimed in claim 1, wherein, by way of reading out and transforming by the micro control unit, the sensor switch device utilizes natural laws of the Ohm's law and Ampere's right-hand rule, etc. to obtain the information of voltage, current and temperature, etc. for energy storage devices or external electric power source.

22. The smart energy storage tank charge/discharge management system as claimed in claim 1, wherein, while an abnormal condition occurred, the central control unit can store the related abnormal information and login time in the data access unit so as to be the reference message for abnormal causes diagnosing and performance improving.

23. The smart energy storage tank charge/discharge management system as claimed in claim 1, wherein, after the charging process completed, the central control unit accumulates the discharge capacity for which discharged by each energy storage device so as to determine the energy storage ability of the energy storage device and issue a warning message for the capacity difference reached and above a certain level differ from other energy storage devices.

24. The smart energy storage tank charge/discharge management system as claimed in claim 1, wherein, at the moment when charging process completed, the central control unit accumulates the charge capacity and adjust the energy storage ability for each energy storage device so as to provide a reference basis for exchanging a new energy storage device.

25. The energy storage management module as claimed in claim 3, after lost the connection with the central control unit, can hold the original function for protecting the charging and discharging of energy storage device by standalone management way.
